(19) United States
(12) Patent Application Publication
(10) Pub. No.: US 2022/0321348 A1
(43) Pub. Date: Oct. 6, 2022

(54) INFORMATION COLLATION SYSTEM, CLIENT TERMINAL, SERVER, INFORMATION COLLATION METHOD, AND INFORMATION COLLATION PROGRAM

(71) Applicant: NEC Corporation, Minato-ku, Tokyo (JP)

(72) Inventor: Toshiyuki ISSHIKI, Tokyo (JP)

(73) Assignee: NEC Corporation, Minato-ku, Tokyo (JP)

(21) Appl. No.: 17/640,583

(22) PCT Filed: Sep. 18, 2019
(86) PCT No.: PCT/JP2019/036523

§ 371 Date: Mar. 4, 2022

(51) Int. Cl. H04L 9/32

(52) U.S. Cl. CPC H04L 9/3218; H04L 9/3231

(57) ABSTRACT

In order to provide a system and the like which is secure in information collation against an attack in which a data space of one piece of data for registration and authentication is different from a data space of the other piece of the data, the system includes a registration data generation apparatus (100) generating a first commitment of first input data for registration, and first proof data indicating that the first input data is included in a predetermined input data space, a registration data verification apparatus (200) verifying the first commitment and the first proof data, an authentication data generation apparatus (500) generating a second commitment of second input data to be authenticated, and second proof data indicating that the second input data is included in the predetermined input data space and that a similarity between the second input data and registration data in a registration data storage apparatus (300) is included in a predetermined acceptance range, and an authentication data verification apparatus (600) verifying the second commitment and the second proof data.

### BACKGROUND

### Technical Field

The present invention relates to an information collation system, a client terminal, a server, an information collation method, and an information collation program.

### Background Art

Personal authentication is means for confirming identicalness between a registered person and a person to be authenticated. Information related to a registered person that is stored in advance is checked against information related to a person to be authenticated that is acquired every authentication to perform the authentication.

In biometric authentication as a scheme of the personal authentication, physical characteristics such as a face, a fingerprint, and an iris are used to perform the authentication. To be more specific, data called a feature is extracted from a biological body to be used for the authentication. The feature extracted from the biological body is slightly different every extraction. As such, in authentication, a feature extracted from a registered person is compared with a feature extracted from a person to be authenticated, and when these features are recognized to be sufficiently similar to each other, the authentication is successful. A similarity determination method depends on a feature extraction scheme, and in a general scheme, a feature is expressed in a form of a vector, a similarity is calculated by way of an inner product of two features (normalized correlation), a Euclidean distance between the two features, a Hamming distance between the two features, and the like, and then, in a case that the similarity is included in a predetermined range, the sufficient similarity is determined.

Merits of the biometric authentication, as compared to authentication by way of memorizing a password and the like, or authentication by way of carrying an IC card and the like, include higher convenience that an active preparation by a user such as the memorization and the carrying is not necessary for inputting authentication information, and higher security that the authentication information is not likely to be used by other persons. In recent years, the biometric authentication has been increasingly used as means for the personal authentication, along with development in technologies such as a feature extraction method, and popularization of a device equipped with a sensor functionality (for example, a camera) capable of capturing the biological information (for example, smartphone, tablet terminal, and the like).

An example of the biometric authentication technology is known in which zero-knowledge proof is used. For example, PTL 1 discloses a conversion parameter proof function, in a biometric authentication system or the like, to prove that a device knows a correct conversion parameter without disclosing knowledge related to the conversion parameter to an authentication server. PTL 1 also discloses that such a proof can be achieved using zero-knowledge proof or the like (for example, see paragraphs [0042] and [0051]).

### CITATION LIST

### Patent Literature

[PTL 1] JP 2008-092413 A

### Non Patent Literature

[NPL 1] Taher ElGamal, “A public key cryptosystem and a signature scheme based on discrete logarithms,” IEEE transactions on information theory 31.4 (1985): 469-472.

### SUMMARY

### Technical Problem

In an information collation system using an encryption system such as an additive homomorphic public key cryptosystem, input data is encrypted to be concealed, and thus, an attack using data not generated from a biological body is assumed. A secure scheme is demanded against an attack using registration data or authentication data generated from such data that is not generated from the biological body.

For example, it is possible to generate data to be registered, or generate data to be authenticated, with the use of the data not generated from the biological body as an input. In an information collation system biological body using the additive homomorphic public key cryptosystem described above, the input data is encrypted to be concealed, and thus, examples of the above-described attack assumed may include an attack using the data not generated from the biological body to generate registration data, to thereby generate registration data that matches in many biological body features and is possibly determined to be authentication accept, and an attack attempting to acquire or leak information related to the biological body feature used in the authentication. Also assumed are an attack in which the data not generated from the biological body is input to generate data to be authenticated, to thereby generate data possibly determined to be authentication acceptance (authenticated data), and an attack attempting to acquire or leak information related to the registered biological body feature.

Moreover, such a problem is not limited to the biological information, and a similar problem may apply to an attack using registration data or authentication data generated from data of a data space different from a predetermined data space. Here, the data space refers to, for example, a possible range of a value, property, or the like of data (value) constituting data to be registered or data to be authenticated such as the biological information.

An example object of the present invention is to provide an information collation system, a client terminal, a server, an information collation method, and an information collation program which are secure in information collation even against an attack using registration data or authentication data generated from data of a data space different from a predetermined data space. As an example, an example object of the present invention is to provide a scheme secure against an attack using the data not generated from the biological body in the information collation using biological information.

### Solution to Problem

An information collation system according to the present invention includes: a registration data generation apparatus configured to generate a first commitment of first input data for registration, and first proof data indicating that the first input data is included in a predetermined input data space; a data-for-authentication storage apparatus configured to store part or all of the first commitment and the first proof data; a registration data verification apparatus configured to verify the first commitment and the first proof data; a registration data storage apparatus configured to store part or all of the first commitment and the first proof data as registration data; an authentication data generation apparatus configured to generate a second commitment of second input data to be authenticated, and second proof data indicating that the second input data is included in the predetermined input data space and that a similarity between the second input data and the registration data of the registration data storage apparatus is included in a predetermined acceptance range; and an authentication data verification apparatus configured to verify the second commitment and the second proof data.

A client terminal according to the present invention includes: a registration data generation section configured to generate registration data including a first commitment of first input data for registration and first proof data indicating that the first input data is included in a predetermined input data space; a data-for-authentication storage section configured to store part or all of the first commitment and the first proof data; and an authentication data generation section configured to generate a second commitment of second input data to be authenticated, and second proof data indicating that the second input data is included in the predetermined input data space and that a similarity between the second input data and the registration data is included in a predetermined acceptance range.

A server according to the present invention includes at least one of: a registration data verification section configured to receive, as inputs, a first commitment of first input data for registration, and first proof data indicating that the first input data is included in a predetermined input data space, and verify the first commitment and the first proof data; and an authentication data verification section configured to receive, as inputs, a second commitment of second input data to be authenticated, and second proof data indicating that the second input data is included in the predetermined input data space and that a similarity between the second input data and registration data in a registration data storage section is included in a predetermined acceptance range, and verify the second commitment and the second proof data.

An information collation method according to the present invention includes: registration data generation processing of generating a first commitment of first input data for registration, and first proof data indicating that the first input data is included in a predetermined input data space; data-for-authentication storage processing of storing part or all of the first commitment and the first proof data; registration data verification processing of verifying the first commitment and the first proof data; registration data storage processing of storing part or all of the first commitment and the first proof data as registration data; authentication data generation processing of generating a second commitment of second input data to be authenticated, and second proof data indicating that the second input data is included in the predetermined input data space and that a similarity between the second input data and the registration data of a registration data storage apparatus is included in a predetermined acceptance range; and authentication data verification processing of verifying the second commitment and the second proof data.

An information collation program according to the present invention causes a computer to execute: registration data generation processing of generating a first commitment of first input data for registration, and first proof data indicating that the first input data is included in a predetermined input data space; data-for-authentication storage processing of storing part or all of the first commitment and the first proof data; registration data verification processing of verifying the first commitment and the first proof data; registration data storage processing of storing part or all of the first commitment and the first proof data as registration data; authentication data generation processing of generating a second commitment of second input data to be authenticated, and second proof data indicating that the second input data is included in the predetermined input data space and that a similarity between the second input data and the registration data of a registration data storage apparatus is included in a predetermined acceptance range; and authentication data verification processing of verifying the second commitment and the second proof data.

### Advantageous Effects of Invention

According to the present invention, it is possible to provide an information collation system, a client terminal, a server, an information collation method, and an information collation program which are secure in information collation against an attack in which a data space of one piece of data for registration and authentication is different from a data space of the other piece of data. As an example, according to the present invention, it is possible to provide a scheme secure against an attack using the data not generated from the biological body in the information collation using biological information. Note that, according to the present invention, instead of or together with the above effects, other effects may be exerted.

### BRIEF DESCRIPTION OF THE DRAWINGS

FIG. 1 is a block diagram illustrating a specific configuration of an information collation system according to an example embodiment of the present invention.

FIG. 2 is a flowchart of registration processing according to the present example embodiment.

FIG. 3 is a flowchart of collation processing according to the present example embodiment.

FIG. 4 is a block diagram illustrating a hardware configuration of an apparatus according to the present example embodiment.

FIG. 5 is a block diagram illustrating an example of the information collation system according to the present example embodiment.

FIG. 6 is a block diagram illustrating an example of a client terminal according to the present example embodiment.

FIG. 7 is a block diagram illustrating an example of a server according to the present example embodiment.

### DESCRIPTION OF THE EXAMPLE EMBODIMENTS

Hereinafter, example embodiments of the present invention will be described in detail with reference to the accompanying drawings. Note that, in the Specification and drawings, elements to which similar descriptions are applicable are denoted by the same reference signs, and overlapping descriptions may hence be omitted.

Descriptions will be given in the following order.

1. Related Art

2. Overview of Example Embodiments according to the Present Invention

3. Example Embodiment
3.1. Configuration of System
3.2. Registration and Collation Operations
3.3. Example 1
3.4. Example 2

4. Other Example Aspects

### 1. RELATED ART

Personal authentication is means for confirming identicalness between a registered person and a person to be authenticated. Information related to a registered person that is stored in advance is checked against information related to a person to be authenticated that is acquired every authentication to perform the authentication.

In biometric authentication as a scheme of the personal authentication, physical characteristics such as a face, a fingerprint, and an iris are used to perform the authentication. To be more specific, data called a feature is extracted from a biological body to be used for the authentication. The feature extracted from the biological body is slightly different every extraction. As such, in authentication, a feature extracted from a registered person is compared with a feature extracted from a person to be authenticated, and when these features are recognized to be sufficiently similar to each other, the authentication is successful. A similarity determination method depends on a feature extraction scheme, and in a general scheme, a feature is expressed in a form of a vector, a similarity is calculated by way of an inner product of two features (normalized correlation), a Euclidean distance between the two features, a Hamming distance between the two features, and the like, and then, in a case that the similarity is included in a predetermined range, the sufficient similarity is determined.

Merits of the biometric authentication, as compared to authentication by way of memorizing a password and the like, or authentication by way of carrying an IC card and the like, include higher convenience that an active preparation by a user such as the memorization and the carrying is not necessary for inputting authentication information, and higher security that the authentication information is not likely to be used by other persons. In recent years, the biometric authentication has been increasingly used as means for the personal authentication, along with development in technologies such as a feature extraction method, and popularization of a device equipped with a sensor functionality (for example, a camera) capable of capturing the biological information (for example, smartphone, tablet terminal, and the like).

On the other hand, the biometric authentication has a demerit that biological information unvarying whole life long cannot be changed even if leaked. A biological body feature is defined to fall under the personal information in the General Data Protection Regulation in Europe or the Personal Information Protection Law in Japan. Data falling under the personal information has a restriction in storing or handling such as provision to the outside. Not only the restriction by law or the like but also an attention for being socially accepted is often demanded. In general, in view of personal information protection, a biometric authentication scheme is desirable that a verifier (for example, an authentication server or the like) side does not hold information related to the biological information of a user. As such, in the scheme, it is desirable that in consideration of also an attack against a terminal that the user has (for example, a smartphone), even if the terminal held by the user is hacked by malware or the like, the biological information cannot be restored.

Then, a biometric authentication scheme has been eagerly studied that the biological information is concealed and stored, and an authentication result can be determined with the concealed state being kept. Known as means for achieving the determination with the concealed state being kept is a scheme using a public key cryptosystem with additive homomorphism.

The public key cryptosystem includes three algorithms of a key generation algorithm (KeyGen), an encryption algorithm (Enc), and a decryption algorithm (Dec). The key generation algorithm uses a parameter indicating a strength of a key, called a security parameter, to generate an encryption key ek and a decryption key dk. This operation can be expressed as a relationship below, where the security parameter is represented by κ.

KeyGen(K)→(ek,dk)

The encryption algorithm generates a ciphertext c as a result of encrypting a plaintext message m by use of the encryption key ek. This can be expressed as a relationship below.

Enc(ek,m)→c

The decryption algorithm generates m′ as a result of decrypting the ciphertext c by use of the decryption key dk. This can be expressed as a relationship below.

Dec(dk,c)→m′

The public key cryptosystem needs to be able to correctly decrypt the ciphertext. Specifically, as for any pair of encryption key ek and decryption key dk generated by the key generation algorithm, with respect to any message m, the decoding result m′ is required to be equal to m when the message m is encrypted by use of the encryption key ek to result in a ciphertext c and the ciphertext c is decrypted by use of the decryption key dk to result in m′. Specifically, for KeyGen(κ)→(ek, dk),

Dec(dk,Enc(ek,m))→m

needs to be satisfied for any m.

In the public key cryptosystem, any device having an encryption key can perform the encryption algorithm, but cannot successfully perform the decryption algorithm without a decryption key.

The public key cryptosystem with homomorphism (hereinafter, referred to as the homomorphic public key cryptography) includes a homomorphic arithmetic algorithm (Hom) in addition to the algorithms of the public key cryptography.

The homomorphic arithmetic algorithm generates ciphertexts as result of an arithmetic performed on messages corresponding to a plurality of input ciphertexts c₁ and c₂ by use of the encryption key ek. When two messages can be input, the algorithm can be expressed as a relationship below.

Hom(ek,c₁,c₂)→c

For example, in a case of a public key cryptography with additive homomorphism, the ciphertext c generated from the ciphertext c₁ of a message m₁ by use of the encryption key ek and the ciphertext c₂ of a message m₂ by use of the encryption key ek is a ciphertext of m₁+m₂. Specifically, assuming that, with respect to KeyGen(κ)→(ek, dk),

Enc(ek,m₁)→c₁,Enc(ek,m₂)→c₂

for any m₁ and m₂,

Dec(dk,Hom(ek,c₁,c₂))→m₁+m₂

is satisfied.

The known public key cryptography with additive homomorphism includes the elliptic curve Elgamal encryption, or the like. Algorithms of the elliptic curve Elgamal encryption disclosed in NPL 1 operate as below.

The key generation algorithm firstly receives the security parameter κ as an input. Next, κ-bit prime number q is chosen at random to choose a generating element G of a group with an order q on an elliptic curve E. Next, an integer x equal to or more than 1 and less than q is chosen at uniformly random, and H is obtained by H=[x]G. Finally, encryption key ek=(κ, E, G, H) and decryption key dk=(ek, x) are output.

The encryption algorithm firstly receives the encryption key ek=(κ, G, g, H) and a message m as inputs. Next, an integer r equal to or more than 1 and less than q is chosen at uniformly random, and Cₐ and C_{b} are obtained by Cₐ:=[r]G, and C_{b}:=[m]G+[r]H, respectively. Finally, ciphertext c=(Cₐ, C_{b}) is output.

The decryption algorithm firstly receives the decryption key dk=(ek, x) and the ciphertext c=(Cₐ, C_{b}) as inputs. Next, M′=C_{b}−[X]Cₐ is calculated. Finally, decryption result m′=Dlog_{G}(M′) is output. Here, Dlog is a function satisfying Dlog_{G}([x]G)=x.

As for the ciphertext c of the message m=(Cₐ, C_{b})=([r]G, [m]G+[r]H), the ciphertext c can be correctly decrypted to m by the decryption algorithm of the elliptic curve Elgamal encryption, which can be confirmed by an equation below.

M′=C_{b}−[x]·Cₐ=([m]G+[r]H)−[x]·([r]G)=[m]G+[r]([x]·G)−[x]·([r]G)=[m]G

The homomorphic arithmetic algorithm firstly receives the encryption key ek=(κ, G, g, h) and a first ciphertext c₁=(C_{1, a}, C_{1, b}) and a second ciphertext c₂=(C_{2, a}, C_{2, b}) as inputs. Next, Cₐ=C_{1, a}+C_{2, a} and C_{b}=C_{1, b}+C_{2, b} are calculated. Finally, a homomorphic arithmetic result c=(Cₐ, C_{b}) is output.

For ciphertexts of the message m₁ (C_{1, a}=[r]G, C_{1, b}=[m₁]G [r]H) and ciphertexts of the message m₂ (C_{2, a}=[s]G, C_{2, b}=[m₂]G+[s]H), two equations below are satisfied.

Cₐ=[r+s]·G

C_{b}=[m₁+m₂]G+[r+s]H

Accordingly, c is a ciphertext of m₁+m₂, and the elliptic curve Elgamal encryption has additive homomorphism.

An overview of an information collation system using the additive homomorphic encryption will be described below.

In the information collation system, input data is an n-dimensional natural number vector (n represents a natural number). Specifically, the input data can be expressed as x=(x1, x2, . . . , xn). Similarity between input data x and input data y is expressed as sim(x, y). In general, for sim(x, y), a squared Euclidean distance, Hamming distance, and normalized correlation of both data x and y, or the like are used. It is known that these can be calculated in a state of being encrypted, using the additive homomorphism.

(Registration Stage)

Each xi (i=1 to n) of the input data x=(x1, x2, . . . , xn) is encrypted with the additive homomorphic encryption. Specifically, {Enc(ek, xi)} is generated and stored.

(Authentication Stage)

An encrypted similarity Enc(ek, sim(x, y)) between x and y is calculated by using each yi (i=1 to n) of the input data y=(y1, y2, . . . , yn) and a homomorphic arithmetic operation Hom.

The encrypted similarity Enc(ek, sim(x, y)) is decrypted to obtain the similarity, and thus authentication acceptance or nonacceptance is determined.

Here, assuming a biological body feature as the input data, an input data space is predefined in many biometric authentication schemes. Specifically, it has been defined that a value of each xi is a predetermined natural number equal to or more than a and equal to or less than b, and x is a n-dimensional vector. For example, the biometric authentication scheme using the Hamming distance for the similarity, it has been defined that each xi is 0 or 1, and the dimension number n is 1024, 2048, or the like.

On the other hand, a plaintext space for the additive homomorphic encryption (space of an encryptable message) is determined by a security parameter, and is not necessarily the same as the input data space. For example, in the information collation system using the Hamming distance for the similarity (for example, biometric authentication or the like), each xi is 0 or 1, but the plaintext space for the additive homomorphic encryption to be used may be often a set of remainders when dividing by 2048-bit prime number q.

A system being secure even against an attack utilizing unmatching between the input data space and the plaintext space for the encryption system is demanded. In general, it is difficult to detect such an attack being made.

The case of the information collation system using the Hamming distance for the similarity is described in the foregoing example, but it is known that the system can be attacked by a similar manner even in a case of using other similarity metrics (for example, squared Euclidean distance, normalized correlation, or the like). The case of using the additive homomorphic encryption is described in the foregoing example, but it is desirable that the system is secure against the similar attack even in a case of using other homomorphic encryptions (multiplication, Somewhat, complete) or a linear mask.

### 2. OVERVIEW OF EXAMPLE EMBODIMENTS ACCORDING TO THE PRESENT INVENTION

Firstly, an overview of example embodiments according to the present invention will be described.

(1) Technological Issue

A system and the like are desired which is secure in information collation against an attack in which a data space of one piece of data for registration and authentication is different from a data space of the other piece of data.

(2) Technical Features

In an example embodiment according to the present invention, for example, an information collation system includes a registration data generation apparatus configured to generate a first commitment of first input data for registration, and first proof data indicating that the first input data is included in a predetermined input data space, a data-for-authentication storage apparatus configured to store part or all of the first commitment and the first proof data, a registration data verification apparatus configured to verify the first commitment and the first proof data, a registration data storage apparatus configured to store part or all of the first commitment and the first proof data as registration data, an authentication data generation apparatus configured to generate a second commitment of second input data to be authenticated, and second proof data indicating that the second input data is included in the predetermined input data space and that a similarity between the second input data and the registration data of the registration data storage apparatus is included in a predetermined acceptance range, and an authentication data verification apparatus configured to verify the second commitment and the second proof data.

This provides a system which is secure in information collation against an attack in which a data space of one piece of data for registration and authentication is different from a data space of the other piece of data.

Note that the technical features described above are merely examples according to the example embodiment of the present invention, and of course, the example embodiment of the present invention is not limited to the technical features described above.

Example embodiments of the present invention will be described in detail with reference to the drawings. Note that in the drawings and the example embodiments described in the Specification, similar components are denoted by the same reference signs, and the descriptions thereof are adequately omitted.

### 3. EXAMPLE EMBODIMENT

### 3.1. Configuration of System

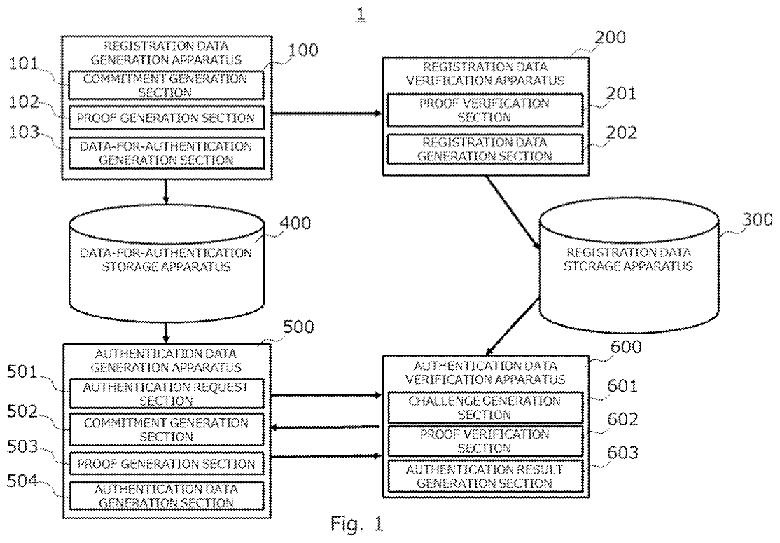

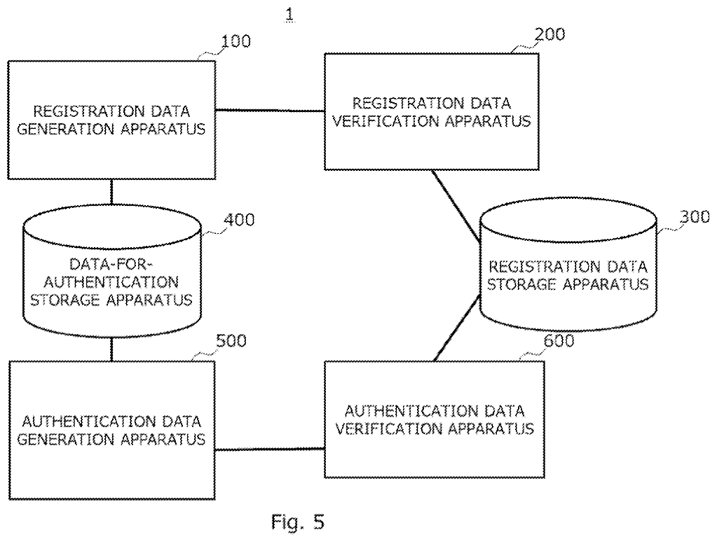

FIG. 5 is a block diagram illustrating an example of an information collation system 1 according to the present example embodiment. FIG. 1 is a block diagram illustrating a specific configuration of the information collation system 1 according to the present example embodiment.

For example, as illustrated in FIG. 5, the information collation system 1 includes, for example, a registration data generation apparatus 100, a registration data verification apparatus 200, a registration data storage apparatus 300, a data-for-authentication storage apparatus 400, an authentication data generation apparatus 500, and an authentication data verification apparatus 600. However, the above respective apparatuses may be mounted as separate apparatuses, or part or all thereof may be mounted on an identical apparatus.

For example, the registration data generation apparatus 100, the data-for-authentication storage apparatus 400, and the authentication data generation apparatus 500 may be mounted on an identical client terminal, and the registration data verification apparatus 200, the registration data storage apparatus 300, and the authentication data verification apparatus 600 may be separately mounted on respective servers, which can realize a client-server type authentication system.

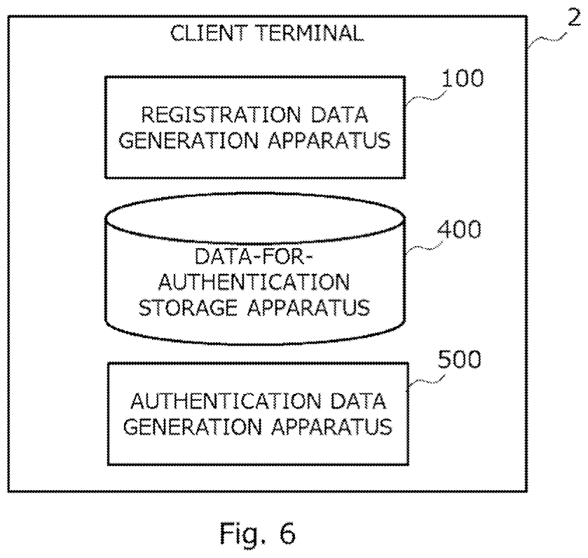

FIG. 6 is a block diagram illustrating an example of a client terminal according to the present example embodiment. As illustrated in a specific example in FIG. 6, a client terminal 2 includes the registration data generation apparatus 100, the data-for-authentication storage apparatus 400, and the authentication data generation apparatus 500.

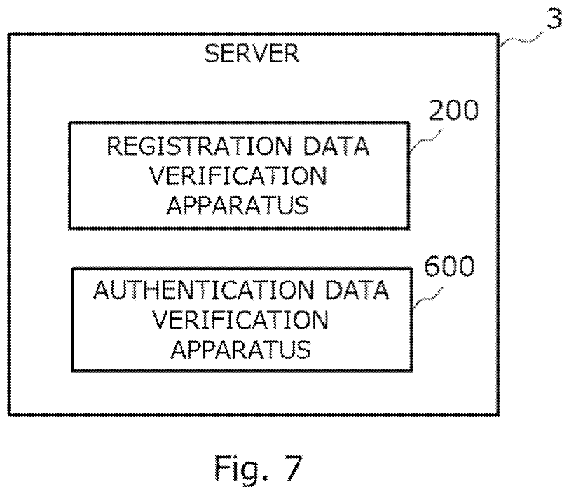

FIG. 7 is a block diagram illustrating an example of a server according to the present example embodiment. As illustrated in FIG. 7, a server 3 includes any one or both of the registration data verification apparatus 200 and the authentication data verification apparatus 600. Note that the server 3 may include the registration data storage apparatus 300, or may be externally connected to the registration data storage apparatus 300.

Note that the registration data generation apparatus 100, the registration data verification apparatus 200, the registration data storage apparatus 300, the data-for-authentication storage apparatus 400, the authentication data generation apparatus 500, and the authentication data verification apparatus 600 constituting the information collation system 1 may be referred to as a registration data generation section, a registration data verification section, a registration data storage section, a data-for-authentication storage section, an authentication data generation section, and an authentication data verification section, respectively, and one or a plurality of nodes (apparatuses) may include one or a plurality of the above-described sections.

The registration data generation apparatus 100 includes, for example, a commitment generation section 101, a proof generation section 102, and a data-for-authentication generation section 103. The commitment generation section 101 receives, as inputs, input data (first input data) and a parameter to generate a commitment (a first commitment) based on the input data. Here, the input data, which is data for registration (registration data), is biological information, for example. The input data here is also referred to as the first input data or the input data x in the Specification. The parameter is a parameter used in obtaining a commitment, for example. A type of the input parameter can be predefined. The proof generation section 102 receives, as inputs, the input data, the parameter, and the generated commitment to generate proof data (first proof data) indicating that the input data is included in a predetermined input data space. The parameter here is a parameter used in generating the proof data obtained through zero-knowledge proof, for example. A type of the input parameter can be predefined. The proof data can be obtained through the zero-knowledge proof described later, for example. The data-for-authentication generation section 103 receives, as inputs, the generated commitment, the generated proof data, and an identifier (ID) of the registration data received from a registration data generation section in the registration data verification apparatus 200 to generate data for authentication. The data for authentication can include the identifier (ID) of the registration data, and a random number or the like used in generating the commitment (the first commitment) of the above-described input data (the first input data), for example.

The registration data verification apparatus 200 includes a proof verification section 201 and a registration data generation section 202, for example. The proof verification section 201 receives, as inputs, a parameter, the commitment received from the registration data generation apparatus 100, and the proof data to verify that the input data is included in the input data space. Here, the parameter is a parameter used in verifying that the input data is included in the data space, for example. A type of the input parameter can be predefined. The registration data generation section 202 generates an identifier (ID) for registration data and the registration data, based on a parameter, the commitment received from the registration data generation apparatus 100, the proof data, and a verification result. Here, a type of the input parameter can be predefined. For example, the parameter may be a parameter registered as the registration data. Here, the registration data can include part or all of the commitment (the first commitment) of the input data (the first input data) described above and the proof data (the first proof data).

The registration data storage apparatus 300 receives, as inputs, the identifier (ID) of the registration data and the registration data to store those pieces of data made to be paired (in association with each other), in other words, stores (the ID, the registration data).

The data-for-authentication storage apparatus 400 receives the data for authentication generated by the data-for-authentication generation section 103 in the registration data generation apparatus 100 to store the data for authentication.

The authentication data generation apparatus 500 includes, for example, an authentication request section 501, a commitment generation section 502, a proof generation section 503, and an authentication data generation section 504. The authentication request section 501 receives, as an input, the identifier (ID) included in the data for authentication received (extracted) from the data-for-authentication storage apparatus 400 to generate an authentication request including the identifier (ID). The commitment generation section 502 receives, as inputs, a challenge received from the authentication data verification apparatus 600 with respect to the authentication request, a parameter, the data for authentication, and input data (second input data) to generate a commitment (a second commitment). Here, the input data, which is to be authenticated and is to be collated with the registration data, is biological information, for example. The input data here is also referred to as the second input data or the input data y in the Specification. The proof generation section 503 receives, as inputs, the input data, the parameter, and the commitment to generate proof data (a second proof data) indicating that the input data is included in the input data space, and that a similarity between the input data and the registration data is included in a predetermined acceptance range. The authentication data generation section 504 receives, as inputs, the commitment and the proof data to generate authentication data.

The authentication data verification apparatus 600 includes, for example, a challenge generation section 601, a proof verification section 602, and an authentication result generation section 603. The challenge generation section 601 receives, as input, the authentication request received from authentication data generation apparatus 500. The challenge generation section 601 receives (extracts) the registration data corresponding to the identifier (ID) of the registration data included in the authentication request from the registration data storage apparatus 300 to generate a challenge from a prescribed parameter and the registration data. The proof verification section 602 receives, as inputs, a parameter, the authentication data received from the authentication data generation apparatus 500, and the challenge. The proof verification section 602 verifies the proof data included in the authentication data to generate a verification result. The authentication result generation section 603 generates an authentication result based on the verification result.

### 3.2. Registration and Collation Operations

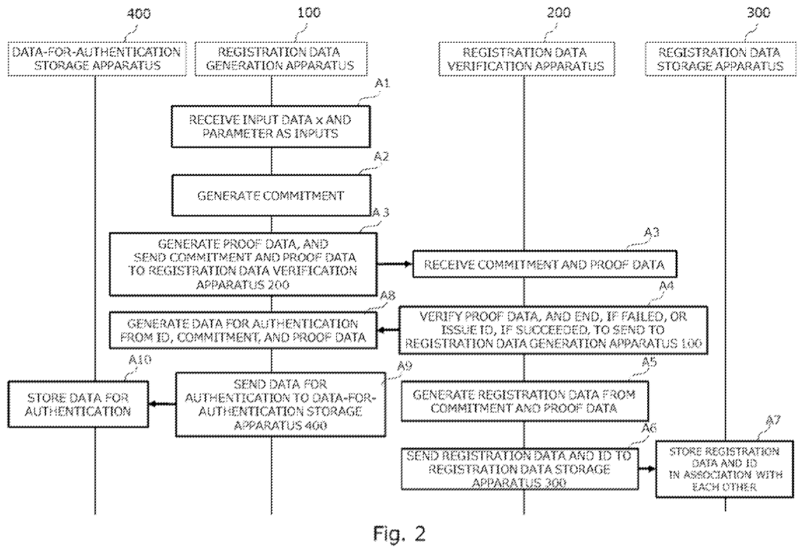

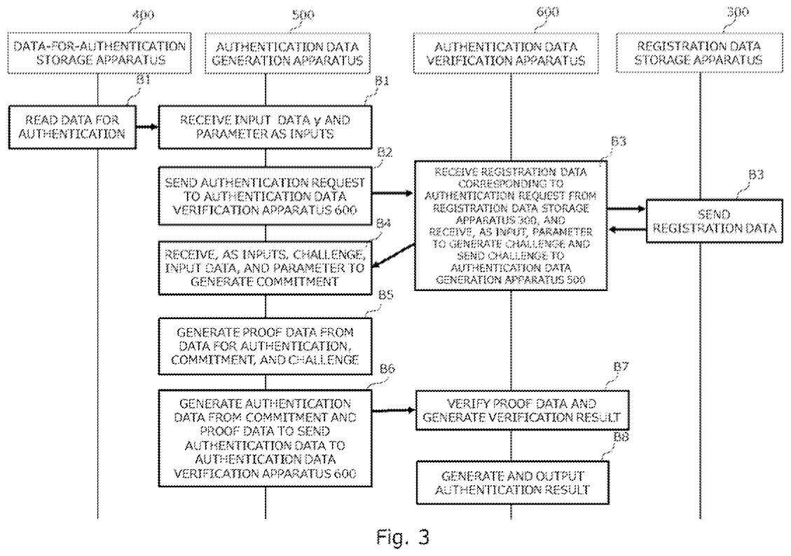

Next, with reference to FIG. 2 and FIG. 3, operations of the information collation system 1 according to the present example embodiment will be described. FIG. 2 illustrates a registration operation on the input data, and FIG. 3 illustrates a collation operation on the input data and the registration data. Note that in the present example embodiment, as for sending (transmitting) and receiving of the data, the data may be directly transmitted and/or received between the respective apparatuses, or the data may be communicated in such an indirect scheme that one apparatus stores the data in an adequate storage section and another apparatus reads out the data.

Firstly, the registration operation is described. First, the commitment generation section 101 in the registration data generation apparatus 100 acquires the input data and the parameter described above (step A1). Note that the parameter is public information including the security parameter, the acceptance range, and a possible range (space) of the input data, and a generating means thereof is not specifically limited. For example, the registration data verification apparatus 200 or the authentication data verification apparatus 600 may have a parameter generating function, or the parameter may be generated outside the information collation system 1.

The commitment generation section 101 receives, as inputs, the input data and the parameter described above to generate a commitment (step A2). The proof generation section 102 receives, as inputs, the input data, the parameter, and the commitment described above to generate proof data indicating that the input data is included in a predetermined input data space, and send the commitment and the proof data to the registration data verification apparatus 200 (step A3).

The proof verification section 201 in the registration data verification apparatus 200 receives the commitment and the proof data from the registration data generation apparatus (step A3). The proof verification section 201 verifies the proof data (step A4). For example, the proof verification section 201 receives, as inputs, a prescribed parameter, the commitment, and the proof data. The proof verification section 201 verifies the proof data, and ends the processing in a case that the verification is failed (nonacceptance). On the other hand, the proof verification section 201, in a case that the verification is succeeded (acceptance), generates an identifier (ID) of the registration data to send the generated ID to the registration data generation apparatus 100. Here, the identifier (ID) is an identifier specific to the registration data, and a generating means thereof is not limited. For example, the identifier (ID) may be a counter value that increases every time the identifier (ID) is generated, or may be a random number value.

The registration data generation section 202 receives, as inputs, the commitment and the proof data to generate registration data (step A5). The registration data generation section 202 sends the identifier (ID) and the registration data to the registration data storage apparatus 300 (step A6). The registration data storage apparatus 300 receives the identifier (ID) and the registration data, and stores a pair of (ID, registration data) (step A7).

The data-for-authentication generation section 103 in the registration data generation apparatus 100 generates data for authentication from the identifier (ID) transmitted from the registration data verification apparatus 200 in step A4, the commitment, and the proof data (step A8). The data-for-authentication generation section 103 sends the data for authentication to the data-for-authentication storage apparatus 400 (step A9). The data-for-authentication storage apparatus 400 receives the data for authentication, and stores the data for authentication (step A10).

Next, the collation operation is described with reference to FIG. 3. First, the authentication request section 501 in the authentication data generation apparatus 500 receives, as inputs, input data y and a parameter, and further, receives the data for authentication from the data-for-authentication storage apparatus 400 (step B1). The authentication request section 501 generates an authentication request from the input data y, the parameter, the data for authentication to send the generated authentication request to the authentication data verification apparatus 600 (step B2).

The challenge generation section 601 in the authentication data verification apparatus 600 receives (extracts) the registration data corresponding to the identifier (ID) included in the authentication request from the registration data storage apparatus 300, and further, receives, as an input, a parameter to generate a challenge and send the challenge to the authentication data generation apparatus 500 (step B3).

The commitment generation section 502 in the authentication data generation apparatus 500 receives, as inputs, the challenge, the input data y, the parameter, and the data for authentication to generate a commitment (step B4). The proof generation section 503 receives, as inputs, the commitment, the challenge, the input data y, the parameter, and the data for authentication to generate proof data indicating that the input data y is included in a predetermined input data space, and that a similarity between the input data y and the registration data x is included in the acceptance range (step B5). The authentication data generation section 504 receives, as inputs, the commitment and the proof data to generate authentication data and send the authentication data to the authentication data verification apparatus 600 (step B6).

The proof verification section 602 in the authentication data verification apparatus 600 receives, as inputs, the authentication data, the registration data, the challenge, and the parameter to verify the proof data included in the authentication data and generate a verification result (step B7). The authentication result generation section 603 receives, as input, the verification result to generate and output an authentication result (step B8).

### 3.3. Example 1

Next, Example 1 of the operation of the information collation system 1 according to the present example embodiment will be described. In the present example, a case that the normalized correlation is used for the similarity is described. Assume that the input data meets conditions below.

(1) The input data is a n-dimensional integer vector. In other words, x can be represented by x=(x1, x2, . . . , xn), and each xi is an integer.
(2) Each xi is an integer equal to or more than a and equal to or less than b. In other words, a≤xi≤b is satisfied. Here, a and b represent predetermined values, and may be integers, for example.
(3) x is normalized. In other words, for all pieces of input data x=(x1, x2, . . . , xn), (x1)²+(x2)²+ . . . +(xn)²=A (A is a constant equal to or more than 0) is satisfied.
(4) When input data x=(x1, x2, . . . , xn) and input data y=(y1, y2, . . . , yn) are authentication acceptance, an inner product of x and y<x, y>=x1y1+x2y2+ . . . +xnyn is included in an acceptance range Θ.
(5) When input data x=(x1, x2, . . . , xn) and input data y=(y1, y2, . . . , yn) are authentication nonacceptance, an inner product of x and y<x, y>=x1y1+x2y2+ . . . +xnyn is not included in the acceptance range Θ.

Furthermore, in the present example, a Fujisaki-Okamoto commitment is utilized. A commitment (Commit, Open) is a protocol consisting of two phases, a commitment phase and an open phase. In the commitment phase, a sender uses a certain value v and a random number r to generate a commitment Com(v, r) and send the generated commitment Com(v, r) to a receiver. In the open phase, the sender sends v and r to the receiver to open the commitment Com(v, r). Here, the commitment desirably meets confidentiality and a binding property. The confidentiality is a property that information related to v cannot be obtained from the commitment Com(v, r). The binding property is a property that Com(v, r) cannot be opened with v′≠v. The Fujisaki-Okamoto commitment is known to be a commitment scheme meeting the confidentiality and the binding property.

The Fujisaki-Okamoto commitment is described. First, the security parameters k, l, t, and s are given. Currently, for the sake of security, recommended values are 1024 or more for k, 80 or more for l, 160 or more fort, and 80 or more for s, but other values than these may be used. The parameters g, h, and N are given. Here, N represents a product of k-bit prime numbers p and q. Each of g and h is an element chosen at random from a set Z_{N} of remainders when dividing by N, and x satisfying g=h\hat{ }x mod N or y satisfying h=g\hat{ }y mod N is not opened. Here, g\hat{ }x means the x-th power of g, and mod N means a remainder when dividing by N.

(Commitment Phase)

Assume that v is an input, Com(v, r)=g\hat{ }v·h\hat{ }r mod N is a commitment.

(Open Phase)

v and r are sent.

Next, the zero-knowledge proof used in the present example will be described. First, the zero-knowledge proof is a scheme by which a person (prover) proves to another person (verifier) that a proposition is true without disclosing any information except for the fact that the statement is true. In the present example, zero-knowledge proof of knowledge, zero-knowledge proof of range, and zero-knowledge proof of square are used.

As an example, zero-knowledge proof of knowledge of a discrete logarithm is described. Here, assume that a prover knows a discrete logarithm x to g\hat{ }x mod N, and gives a zero-knowledge proof of knowledge of x to a verifier knowing g\hat{ }x. H represents a hash function.

(Proving Stage)

(1) Choose w from [1, 2\hat{ }{l+t+s}−1] at random.
(2) Calculate c=H(g\hat{ }w).

### (3) Calculate D=w+c·s.

(4) Send (c, D) to the verifier.

(Verification Stage)

(1) Check that c=H(g\hat{ }D·(g\hat{ }x){−c}) is satisfied. Determine acceptance if the equation is satisfied, or nonacceptance if not.

Next, zero-knowledge proof of square and zero-knowledge proof of range utilizing the Fujisaki-Okamoto commitment are described.

First, zero-knowledge proof of square is described. A prover gives a zero-knowledge proof that Com(x\hat{ }2, r)=g\hat{ }{x\hat{ }2}·h\hat{ }r is a commitment of the square of x to a verifier knowing Com(x\hat{ }2, r). H represents a hash function.

(Proving Stage)

(1) Choose a random number r2 from [−2\hat{ }s·N+1, 2\hat{ }s·N−1] at random, and calculate F=Com(x, r2)=g\hat{ }{x}·h\hat{ }{r2} mod N.
(2) Calculate r3=r−r2·x, and calculate E=F\hat{ }x·h\hat{ }{r3} mod N.
(3) Choose w from [1, 2\hat{ }{l+t}·N−1], ηF from [1, 2\hat{ }{l+t+s}·N−1], and ηE from [1, 2\hat{ }{l+t+s}·N−1] at random, and calculate WF=g\hat{ }{w}·h\hat{ }{ηF} mod N and WE=F\hat{ }{w}·h\hat{ }{ηE} mod N. Furthermore, calculate c=H(WF∥WE), and calculate D=w+c·x, DF=ηF+c·r2, and DE=ηE+c·r3.
(4) Send (F, c, D, DF, DE) to the verifier.

(Verification Stage)

(1) Check c=H(g\hat{ }D·h\hat{ }{DF}F\hat{ }{−c} mod N∥F\hat{ }{D}·h\hat{ }{DE}·E\hat{ }{−c} mod N). Determine acceptance if the equation is satisfied (the equal sign is true), or nonacceptance if not.

Next, zero-knowledge proof of range is described. A prover gives a zero-knowledge proof that E=Com(x, r)=g\hat{ }x·h\hat{ }r mod N is a commitment of a≤x≤b to a verifier knowing Com(x, r), and a and b. Note that H represents a hash function. floor(x) is a function to truncate decimal places of x.

(Proving Stage)

(1) Give a zero-knowledge proof of knowledge of x.
(2) Calculate E1=E/g\hat{ }a mod N and E2=g\hat{ }b/E mod N. Here, assume x1=x−a and x2=b−x.
(3) Assume x11=floor(√(x1)), x12=x1−(x11)\hat{ }2, x21=floor(√(x2)), and x22=x2−(x21)\hat{ }2.
(4) Choose r11 and r21 from [−2\hat{ }s·N+1, 2\hat{ }s·N−1] at random. Assume r12=r−r11 and r22=−r−r21.
(5) Assume E11=Com((x11)\hat{ }2, r11), E12=Com((x12), r12), E21=Com((x21)\hat{ }2, r21), and E22=Com((x22)\hat{ }2, r22).
(6) Send E11 and E21 to the verifier. The verifier calculates E12=E1/E11 and E22=E2/E21.
(7) Prove that E11 and E21 are the square of x11 and the square of x21, respectively, by use of zero-knowledge proof of square.
(8) Choose w1 and w2 from [0, 2\hat{ }{t+1}·2√(b−a)], and choose η1 and η2 from [−2\hat{ }{t+1+s}N+1, 2\hat{ }{t+1+s}N−1] at random. Calculate W1=g\hat{ }{w1}·h\hat{ }{η1} mod N, W2=g\hat{ }{w2}·h\hat{ }{η2} mod N.
(9) Calculate c=H(W1, W2).
(10) Calculate D11=w1+x12·c, D12=η1+r12·c, D21=W2+x22·c, and D22=η2+r22·c, and send (c, D11, D12, D21, D22) to the verifier.

(Verification Stage)

(1) Verify the zero-knowledge proof of knowledge in the step 1 of the proving and the zero-knowledge proof of square in the step 7. If any one of the proofs is nonacceptance, the verification processing ends.
(2) Check that c=H(g\hat{ }{D11}·h\hat{ }{D12}·E12\hat{ }{−c}, g\hat{ }{D21}·h\hat{ }{D22}·E22\hat{ }{−c}) is satisfied. Output a verification result as acceptance if the equation is satisfied (the equal sign is true), or a verification result as nonacceptance if not.

Next, the registration operation of the information collation system 1 according to the present example will be described. First, the registration data generation apparatus 100 receives, as inputs, a parameter and input data x=(x1, x2, . . . , xn) (step A1).

The commitment generation section 101 performs processing below for i=1, . . . , n.

(1) Generate Ei=Com(xi, ri) and Fi=Com((xi)\hat{ }2, r′i) (step A2). In other words, generate a commitment based on the input data. Here, ri may be included in the parameter input in step A1.

The proof generation section 102 performs processing below for i=1, . . . , n (step A3).

(1) Give four zero-knowledge proofs below. (1) A knowledge proof of xi using Ei, (2) a zero-knowledge proof of a≤xi≤b using Ei, (3) a zero-knowledge proof of the square of xi using Fi.
(2) Furthermore, using F1, . . . , Fn, generate (4) a zero-knowledge proof of Σ(xi)\hat{ }2=(x1)\hat{ }2+(x2)\hat{ }2+ . . . +(xn)\hat{ }2=A. This can be achieved using a zero-knowledge proof of knowledge of Σ(r′i) because F1·F2· . . . ·Fn=g\hat{ }{Σ(xi)\hat{ }2}·h\hat{ }{Σ(r′i)} is satisfied, which leads F1·F2· . . . ·Fn/g\hat{ }A=h\hat{ }{Σ(r′i)}.

The proof generation section 102 sends the commitment and the proof data to the registration data verification apparatus 200 (step A3).

The proof verification section 201 in the registration data verification apparatus 200 receives the commitment and the proof data, and verifies the zero-knowledge proofs described in above (1) to (3). If any one of the proofs is verification nonacceptance, the verification processing ends. On the other hand, when all are verification acceptance, the proof verification section 201 generates an identifier (ID) of the registration data to send the identifier (ID) to the registration data generation apparatus 100 (step A4).

The registration data generation section 202 uses the commitment {Ei} as the registration data (step A5). The registration data generation section 202 sends a pair of the identifier (ID) and the registration data (ID, registration data) to the registration data storage apparatus 300 (step A6). The registration data storage apparatus 300 stores (ID, registration data) (step A7).

The data-for-authentication generation section 103 in the registration data generation apparatus 100 receives the identifier (ID) in step A4, and generates (ID, {ri}) as data for authentication (step A8). The data-for-authentication generation section 103 sends the data for authentication to the data-for-authentication storage apparatus 400 (step A9). The data-for-authentication storage apparatus 400 stores the data for authentication (step A10).

Next, the collation operation of the information collation system 1 according to the present example will be described. First, the authentication request section 501 in the authentication data generation apparatus 500 receives, as inputs, input data y=(y1, y2, . . . , yn) and a parameter, and receives (extracts) the data for authentication (ID, {ri}) from the data-for-authentication storage apparatus 400 (step B1). As an example, a login ID, a user identification number or the like may be input together with the input data y to read out data for authentication associated with these inputs.

The authentication request section 501 sends, as the authentication request, a Request including the identifier (ID) of the registration data to the authentication data verification apparatus 600 (step B2).

The challenge generation section 601 receives (extracts) the registration data (ID, {Ei}) corresponding to the identifier (ID) from the registration data storage apparatus 300 to determine {(Ei)\hat{ }c} and h\hat{ }c as challenges by using a random value c and send the challenges to the authentication data generation apparatus 500 (step B3).

The commitment generation section 502 in the authentication data generation apparatus 500 performs processing below for i=1, 2, . . . , n.

(1) Calculate Com(yi, Ri)=g{yi}·h\hat{ }{Ri} mod N, Com((yi)\hat{ }2, R′i)=g\hat{ }{(yi)\hat{ }2}·h\hat{ }{R′ᵢ} mod N and Com(xiyi, R″i)=((Ei)\hat{ }c)\hat{ }{yi}·h\hat{ }{R″i} mod N (step B4).

The proof generation section 503 performs processing below for i=1, 2, . . . , n. (1) (1) a zero-knowledge proof of knowledge of yi using Com(yi, Ri), (2) a zero-knowledge proof of range of a≤yi≤b using Com(yi, Ri), (3) a zero-knowledge proof of the square of yi using Com((yi)\hat{ }2, R′i).

(2) Next, generate (4) a zero-knowledge proof of Σ(yi)\hat{ }2=(y1)\hat{ }2+(y2)\hat{ }2+ . . . +(yn)\hat{ }2=A. This can be achieved by the similar method to the registration operation.
(3) Next, generate (5) a zero-knowledge proof that <x, y> is included in the acceptance range Θ using Com(xiyi, R″i). This can also be achieved by the similar method to the registration operation. Specifically, because Com(x1y1, R″1)·Com(x2y2, R″2)· . . . ·Com(xnyn, R″n)=g\hat{ }{c<x, y>}(h\hat{ }{c})\hat{ }{Σ(yi·ri)+ΣR″i)} is satisfied, generate a zero-knowledge proof of knowledge of Σ(yi·ri)+Σ(R″i) for h\hat{ }c (step B5).

The authentication data generation section 504 sends the commitment and the proofs (1) to (5) as the proof data to the authentication data verification apparatus 600 (step B6).

The proof verification section 602 verifies the proofs (1) to (5), and determines a verification result as acceptance if all proofs are acceptance, or determines a verification result as nonacceptance if not (step B7). Here, the verification of (4) can be achieved by verifying the zero-knowledge proof because Com((y1)\hat{ }2, R′1)·Com((y2)\hat{ }2, R′2)· . . . ·Com((yn)\hat{ }2, R′n)=g\hat{ }{Σ(yi)\hat{ }2}·h\hat{ }{Σ(R′i)} mod N is satisfied, and Com((y1)\hat{ }2, R′1)·Com((y2)\hat{ }2, R′2)· . . . ·Com((yn)\hat{ }2, R′n)/g\hat{ }{A} is obtained. In a similar manner, the verification of (5) can be achieved by verifying the zero-knowledge proof by Com(x1y1, R″1)·Com(x2y2, R″2)· . . . ·Com(xnyn, R″n)/g\hat{ }{cθ} for a value θ included in the acceptance range Θ.

The authentication result generation section 603 determines an authentication result as acceptance if the verification result is acceptance, or determines an authentication result as nonacceptance if not (step B8).

Note that in the description of the present example, for all dimensions of x and y, xi (or yi) satisfies a≤xi≤b is proved, but a part thereof (for example, a half) may be proved. The dimension to be proved may be chosen in any way without limitation. For example, the dimension to be proved may be chosen at random by the registration data verification apparatus 200 or the authentication data verification apparatus 600.

The description of the present example describes that each zero-knowledge proof is independently performed, but a well-known improvement may be made in being performed in parallel. For example, the hash function is calculated in each of the zero-knowledge proofs, but may be collectively once. Similarly, a proof of knowledge of xi or yi is given in each of the zero-knowledge proofs, but may be collectively once.

Furthermore, in the description of the present example, c is calculated by the registration data generation apparatus 100 and the authentication data generation apparatus 500 using the hash function, but may be replaced with the random number c generated by the registration data verification apparatus 200 and the authentication data verification apparatus 600. At this time, the expressions checked in the verification are replaced with those not checking that hash values match but checking that calculation results related to c match.

Note that in the description of the present example, each zero-knowledge proof is used to prove that the input data is included in the input data space, or that the similarity between the input data and the registration data is included in the acceptance range, but in a case that all are not necessary to be concealed, commitment open may be performed. For example, it is easy to verify that a sum of squares of values of the dimensions of the input data is a constant A even by finding out the random number used for the commitment.

### 3.4. Example 2

Next, Example 2 of the operation of the information collation system 1 according to the present example embodiment will be described.

In the present example, a case that the squared Euclidean distance is used for the similarity is described. Assume that the input data meets conditions below.

(1) The input data is a n-dimensional integer vector. In other words, x can be represented by x=(x1, x2, . . . , xn), and each xi is an integer.
(2) Each xi is an integer equal to or more than a and equal to or less than b. In other words, a≤xi≤b is satisfied.
(3) When input data x=(x1, x2, . . . , xn) and input data y=(y1, y2, . . . , yn) are authentication acceptance, the square of Euclidean distance between x and y, d(x, y)=(x1−y1)\hat{ }2+(x2−y2)\hat{ }2+ . . . +(xn−yn)\hat{ }2 is included in the acceptance range Θ.
(4) When input data x=(x1, x2, . . . , xn) and input data y=(y1, y2, . . . , yn) are authentication nonacceptance, the square of Euclidean distance between x and y, d(x, y)=(x1−y1)\hat{ }2+(x2−y2)\hat{ }2+ . . . +(xn−yn)\hat{ }2 is not included in the acceptance range Θ.

Next, the registration operation of the information collation system 1 according to the present example will be described. First, the registration data generation apparatus 100 receives, as inputs, a parameter and input data x=(x1, x2, . . . , xn) (step A1).

The commitment generation section 101 performs processing below for i=1, . . . , n. In other words, the commitment generation section 101 generates Ei=Com(xi, ri) and Fi=Com((xi)\hat{ }2, r′i) (step A2).

The proof generation section 102 performs processing below for i=1, . . . , n (step A3). In other words, the proof generation section 102 gives three zero-knowledge proofs below. (1) A knowledge proof of xi using Ei, (2) a zero-knowledge proof of a≤xi≤b using Ei, (3) a zero-knowledge proof of the square of xi using Fi.

The proof generation section 102 sends the commitment and the proof data to the registration data verification apparatus 200 (step A3).

The proof verification section 201 in the registration data verification apparatus 200 receives the commitment and the proof data, and verifies the zero-knowledge proofs described in above (1) to (3). The proof verification section 201 ends the verification processing if any one of the proofs is verification nonacceptance. On the other hand, when all are verification acceptance, the proof verification section 201 generates an identifier (ID) of the registration data to send the identifier (ID) to the registration data generation apparatus 100 (step A4).

The registration data generation section 202 uses ({Ei}, F=F1·F2· . . . ·Fn) as the registration data (step A5). The registration data generation section 202 sends a pair of the identifier (ID) and the registration data (ID, registration data) to the registration data storage apparatus 300 (step A6). The registration data storage apparatus 300 stores (ID, registration data) (step A7).

The data-for-authentication generation section 103 in the registration data generation apparatus 100 receives the identifier (ID) in step A4, and generates (ID, {ri}, r′=Σ(r′i)) as data for authentication (step A8). The data-for-authentication generation section 103 sends the data for authentication to the data-for-authentication storage apparatus 400 (step A9). The data-for-authentication storage apparatus 400 stores the data for authentication (step A10).

Next, the collation operation of the information collation system 1 according to the present example will be described. First, the authentication request section 501 in the authentication data generation apparatus 500 receives, as inputs, input data y=(y1, y2, . . . , yn) and a parameter, and receives (extracts) the data for authentication (ID, {ri}, r′) from the data-for-authentication storage apparatus 400 (step B1). As an example, a login ID, a user identification number or the like may be input together with the input data y to read out data for authentication associated with these inputs.

The authentication request section 501 sends, as the authentication request, a Request including the identifier (ID) of the registration data to the authentication data verification apparatus 600 (step B2).

The challenge generation section 601 receives (extracts) the registration data (ID, {Ei}, F) corresponding to the identifier (ID) from the registration data storage apparatus 300 to determine {(Ei)\hat{ }c} and h\hat{ }c as challenges by using a random value c and send the challenges to the authentication data generation apparatus 500 (step B3).

The commitment generation section 502 in the authentication data generation apparatus 500 performs processing below for i=1, 2, . . . , n.

(1) Calculate Com(yi, Ri)=g\hat{ }{yi}·h\hat{ }{Ri} mod N, Com((yi)\hat{ }2, R′i)=g\hat{ }{(yi)\hat{ }2}·h\hat{ }{R′i} mod N and Com(xiyi, R″i)=((Ei)\hat{ }c)\hat{ }{yi}·h\hat{ }{R″i} mod N (step B4).
(2) Next, the proof generation section 503 performs processing below for i=1, 2, . . . , n.
(3) (1) a zero-knowledge proof of knowledge of yi using Com(yi, Ri), (2) a zero-knowledge proof of range of a≤yi≤b using Com(yi, Ri), (3) a zero-knowledge proof of the square of yi using Com((yi)\hat{ }2, R′i).
(4) Next, generate (4) a zero-knowledge proof that d(x, y) is included in the acceptance range Θ by using Com(xiyi, R″i), Com((yi)\hat{ }2, R′i), {ri} and r′. This is because Com (Σ((xi)\hat{ }2), r′)·Com((y1)\hat{ }2, R′1)· . . . ·Com((yn)\hat{ }2, R′n)·(Com((x1y1, R″1)·Com(x2y2, R″2)· . . . ·Com(xnyn, R″n))\hat{ }{−2/c})=g\hat{ }{Σ(xi)\hat{ }2+Σ(yi)\hat{ }2−2<x, y>}(h)\hat{ }{r′+Σ(R′i)+Σ(yi·ri)+Σ(R″i)} is satisfied, and thus, generate a zero-knowledge proof of knowledge of r′+Σ/(R′i)+Σ(yi·ri)+Σ(R″i) for h (step B5).

The authentication data generation section 504 sends the commitment and the proofs (1) to (4) as the proof data to the authentication data verification apparatus 600 (step B6).

The proof verification section 602 verifies the proofs (1) to (4), and determines a verification result as acceptance if all proofs are acceptance, or determines a verification result as nonacceptance if not (step B7).

The authentication result generation section 603 determines an authentication result as acceptance if the verification result is acceptance, or determines an authentication result as nonacceptance if not (step B8).

In the description of the present example, for all dimensions of x and y, xi (or yi) satisfies a≤xi≤b is proved, but a part thereof (for example, a half) may be proved. The dimension to be proved may be chosen in any way. For example, the dimension to be proved may be chosen at random by the registration data verification apparatus 200 or the authentication data verification apparatus 600.

The description of the present example describes that each zero-knowledge proof is independently performed, but a well-known improvement may be made in being performed in parallel. For example, the hash function is calculated in each of the zero-knowledge proofs, but may be collectively once. Similarly, a proof of knowledge of xi or yi is given in each of the zero-knowledge proofs, but may be collectively once.

Furthermore, in the description of the present example, c is calculated by the registration data generation apparatus 100 and the authentication data generation apparatus 500 using the hash function, but may be replaced with the random number c generated by the registration data verification apparatus 200 and the authentication data verification apparatus 600. At this time, the expressions checked in the verification are replaced with those not checking that hash values match but checking that calculation results related to c match.

Note that in the description of the present example, each zero-knowledge proof is used to prove that the input data is included in the input data space, or that the similarity between the input data and the registration data is included in the acceptance range, but in a case that all are not necessary to be concealed, commitment open may be performed.

### (Effects)

One of effects of the present example embodiment described above is that it is impossible to use the data not generated from the biological body as input data to generate registration data or generate authentication data. This allows the more secure information collation system 1 to be achieved. For example, in steps A2 and A3, a zero-knowledge proof can be used to verify that the input data is in a predetermined input data space.

In the present example embodiment described above, the registration data corresponds to a commitment and an identifier (ID) of a Fujisaki-Okamoto commitment. The Fujisaki-Okamoto commitment is known to satisfy information-theoretic confidentiality, and mathematically shows that a commitment of a biological body feature cannot be distinguished from a random number. Therefore, even if a commitment is leaked, the biological body feature is not leaked. The data for authentication corresponds to a random number and an identifier ID used in generating the commitment. Obviously, information related to the biological body feature is not leaked from the data for authentication.

### 4. OTHER EXAMPLE ASPECTS

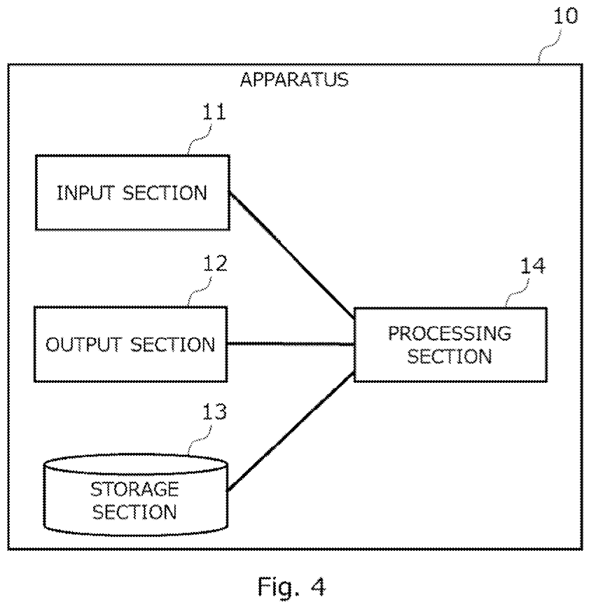

FIG. 4 is a block diagram illustrating a hardware configuration of an apparatus. Each of the apparatuses described above can physically have a configuration below. An apparatus 10 includes, for example, an input section 11, an output section 12, a storage section 13, and a processing section 14.

The input section 11 receives, as inputs, data, information, signals, and the like. The input section 11 may be an interface receiving data and the like from another apparatus, an operation section accepting inputs from a user, a reading apparatus reading biological information, or the like, for example. The output section 12 outputs data, information, signals, and the like. The output section 12 may be an interface transmitting data to another apparatus, a display section displaying a screen, or the like, for example. The storage section 13 transitorily or permanently stores programs and parameters for operations of the apparatus 10 as well as various data. The processing section 14 is constituted by one or more processors such as a Central Processing Unit (CPU), for example. The processing section 14 may execute the program stored in the storage section 13 to perform the operation of each of the apparatuses described above, for example. The program may be a program for causing the processor to execute the operation of each of the apparatuses described above.

The whole or part of the example embodiments disclosed above can be described as in the following supplementary notes, but are not limited to the following.

### (Supplementary Note 1)

An information collation system includes:

a registration data generation apparatus configured to generate a first commitment of first input data for registration, and first proof data indicating that the first input data is included in a predetermined input data space;

a data-for-authentication storage apparatus configured to store part or all of the first commitment and the first proof data;

a registration data verification apparatus configured to verify the first commitment and the first proof data;

a registration data storage apparatus configured to store part or all of the first commitment and the first proof data as registration data;

an authentication data generation apparatus configured to generate a second commitment of second input data to be authenticated, and second proof data indicating that the second input data is included in the predetermined input data space and that a similarity between the second input data and the registration data of the registration data storage apparatus is included in a predetermined acceptance range; and

an authentication data verification apparatus configured to verify the second commitment and the second proof data.

### (Supplementary Note 2)

The information collation system according to supplementary note 1, wherein part or all of the first proof data generated by the registration data generation apparatus is data obtained through zero-knowledge proof.

### (Supplementary Note 3)

The information collation system according to supplementary note 1 or 2, wherein part or all of the second proof data generated by the authentication data generation apparatus is data obtained through zero-knowledge proof

### (Supplementary Note 4)

The information collation system according to any one of supplementary notes 1 to 3, wherein the registration data stored in the registration data storage apparatus includes the first commitment of the first input data.

### (Supplementary Note 5)

The information collation system according to any one of supplementary notes 1 to 4, wherein data for authentication stored in the data-for-authentication storage apparatus includes a random number used in generating the first commitment of the first input data.

### (Supplementary Note 6)

The information collation system according to any one of supplementary notes 1 to 5, wherein part or all of the first commitment generated by the registration data generation apparatus is g\hat{ }x·h\hat{ }r mod N for parameters g, h, and N, the first input data x, and a random number r.

### (Supplementary Note 7)

The information collation system according to any one of supplementary notes 1 to 6, wherein part or all of the second commitment generated by the authentication data generation apparatus is g\hat{ }y·h\hat{ }r mod N for parameters g, h, and N, the second input data y, and a random number r.

### (Supplementary Note 8)

A client terminal including:

a registration data generation section configured to generate registration data including a first commitment of first input data for registration and first proof data indicating that the first input data is included in a predetermined input data space;

a data-for-authentication storage section configured to store part or all of the first commitment and the first proof data; and

an authentication data generation section configured to generate a second commitment of second input data to be authenticated, and second proof data indicating that the second input data is included in the predetermined input data space and that a similarity between the second input data and the registration data is included in a predetermined acceptance range.

### (Supplementary Note 9)

A server including at least one of:

a registration data verification section configured to receive, as inputs, a first commitment of first input data for registration, and first proof data indicating that the first input data is included in a predetermined input data space, and verify the first commitment and the first proof data; and

an authentication data verification section configured to receive, as inputs, a second commitment of second input data to be authenticated, and second proof data indicating that the second input data is included in the predetermined input data space and that a similarity between the second input data and registration data in a registration data storage section is included in a predetermined acceptance range, and verify the second commitment and the second proof data.

### (Supplementary Note 10)

An information collation method including:

registration data generation processing of generating a first commitment of first input data for registration, and first proof data indicating that the first input data is included in a predetermined input data space;

data-for-authentication storage processing of storing part or all of the first commitment and the first proof data;

registration data verification processing of verifying the first commitment and the first proof data;

registration data storage processing of storing part or all of the first commitment and the first proof data as registration data;

authentication data generation processing of generating a second commitment of second input data to be authenticated, and second proof data indicating that the second input data is included in the predetermined input data space and that a similarity between the second input data and the registration data of a registration data storage apparatus is included in a predetermined acceptance range; and

authentication data verification processing of verifying the second commitment and the second proof data.

### (Supplementary Note 11)

An information collation program causing a computer to execute:

registration data generation processing of generating a first commitment of first input data for registration, and first proof data indicating that the first input data is included in a predetermined input data space;

data-for-authentication storage processing of storing part or all of the first commitment and the first proof data;

registration data verification processing of verifying the first commitment and the first proof data;

registration data storage processing of storing part or all of the first commitment and the first proof data as registration data;

authentication data generation processing of generating a second commitment of second input data to be authenticated, and second proof data indicating that the second input data is included in the predetermined input data space and that a similarity between the second input data and the registration data of a registration data storage apparatus is included in a predetermined acceptance range; and

authentication data verification processing of verifying the second commitment and the second proof data.

### INDUSTRIAL APPLICABILITY

As described above, the techniques according to the example embodiments make it possible to securely collate biological information acquired by a sensor such as a camera and biological information of one or a plurality of persons stored in a database with the both biological information being concealed. This is effective in a case that a manager (organization) of the sensor and a manager (organization) of the database are different from each other.

The techniques according to the example embodiments are available when a smartphone or the like is used to perform biometric authentication to a remote server, for example. The data for authentication is registered in a smartphone carried by a user and the registration data is registered in a server, and in performing authentication, the biological information is captured by the smartphone, the authentication data is generated by use of the store data for authentication, and then, the server can authenticate the user.

A usage example of remote biometric authentication using a smartphone includes a usage of Internet shopping or a member service, or the like. The use of the techniques makes it possible for the server to perform user authentication by use of a biometric authentication function of the smartphone concerning the biological information of the user without acquiring except for information related to whether the biological body is identical. Accordingly, a risk of leakage of the user information from the server can be reduced.

### REFERENCE SIGNS LIST

100 Registration Data Generation Apparatus (Registration Data Generation Section)
200 Registration Data Verification Apparatus (Registration Data Verification Section)
300 Registration Data Storage Apparatus (Registration Data Storage Section)
400 Data-for-Authentication Storage Apparatus (Data-for-Authentication Storage Section)
500 Authentication Data Generation Apparatus (Authentication Data Generation Section)
600 Authentication Data Verification Apparatus (Authentication Data Verification Section)

What is claimed is:

1. An information collation system comprising:
a registration data generation apparatus configured to generate a first commitment of first input data for registration, and first proof data indicating that the first input data is included in a predetermined input data space;
a data-for-authentication storage apparatus configured to store part or all of the first commitment and the first proof data;
a registration data verification apparatus configured to verify the first commitment and the first proof data;
a registration data storage apparatus configured to store part or all of the first commitment and the first proof data as registration data;
an authentication data generation apparatus configured to generate a second commitment of second input data to be authenticated, and second proof data indicating that the second input data is included in the predetermined input data space and that a similarity between the second input data and the registration data of the registration data storage apparatus is included in a predetermined acceptance range; and
an authentication data verification apparatus configured to verify the second commitment and the second proof data.

2. The information collation system according to claim 1, wherein part or all of the first proof data generated by the registration data generation apparatus is data obtained through zero-knowledge proof.

3. The information collation system according to claim 1, wherein part or all of the second proof data generated by the authentication data generation apparatus is data obtained through zero-knowledge proof.

4. The information collation system according to claim 1, wherein the registration data stored in the registration data storage apparatus includes the first commitment of the first input data.

5. The information collation system according to claim 1, wherein data for authentication stored in the data-for-authentication storage apparatus includes a random number used in generating the first commitment of the first input data.

6. The information collation system according to claim 1, wherein part or all of the first commitment generated by the registration data generation apparatus is g\hat{ }x·h\hat{ }r mod N for parameters g, h, and N, the first input data x, and a random number r.

7. The information collation system according to claim 1, wherein part or all of the second commitment generated by the authentication data generation apparatus is g\hat{ }y·h\hat{ }r mod N for parameters g, h, and N, the second input data y, and a random number r.

8. A client terminal comprising:
a memory storing instructions; and
one or more processors configured to execute the instructions to:
generate registration data including a first commitment of first input data for registration and first proof data indicating that the first input data is included in a predetermined input data space;
store part or all of the first commitment and the first proof data; and
generate a second commitment of second input data to be authenticated, and second proof data indicating that the second input data is included in the predetermined input data space and that a similarity between the second input data and the registration data is included in a predetermined acceptance range.

9. A server comprising
a memory storing instructions; and
one or more processors configured to execute the instructions to perform at least one of:
processing of receiving, as inputs, a first commitment of first input data for registration, and first proof data indicating that the first input data is included in a predetermined input data space, and verifying the first commitment and the first proof data; and
processing of receiving, as inputs, a second commitment of second input data to be authenticated, and second proof data indicating that the second input data is included in the predetermined input data space and that a similarity between the second input data and registration data in a registration data storage section is included in a predetermined acceptance range, and verifying the second commitment and the second proof data.

10. An information collation method comprising:
generating a first commitment of first input data for registration, and first proof data indicating that the first input data is included in a predetermined input data space;
storing part or all of the first commitment and the first proof data;
verifying the first commitment and the first proof data;
storing part or all of the first commitment and the first proof data as registration data;
generating a second commitment of second input data to be authenticated, and second proof data indicating that the second input data is included in the predetermined input data space and that a similarity between the second input data and the registration data is included in a predetermined acceptance range; and
verifying the second commitment and the second proof data.

11. (canceled)
